(19) United States
(12) Patent Application Publication
(10) Pub. No.: US 2010/0074504 A1
(43) Pub. Date: Mar. 25, 2010

(54) METHOD AND APPARATUS FOR ACQUIRING FUSION X-RAY IMAGES

(75) Inventors: Antonius J.C. Bruijns, Eindhoven (NL); Ronaldus P.J. Hermans, Eindhoven (NL); Peter M.J. Rongen, Eindhoven (NL); Jarl J.P. Blijd, Eindhoven (NL); Herman Stegehuis, Eindhoven (NL); Joerg Bredno, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/532,459

(22) PCT Filed: Mar. 14, 2008
(86) PCT No.: PCT/IB2008/050953

§ 371 Date: Nov. 13, 2009

(30) Foreign Application Priority Data
Mar. 29, 2007 (EP) 07105223.7

(51) Int. Cl. G06K 9/00; G01N 23/04

(52) U.S. Cl. 382/132; 378/62; 382/284

(57) ABSTRACT

A method for acquiring fusion images of a periodically moving body organ and an apparatus adapted to implement such method is described. In a preferred embodiment of the method, X-rays are irradiated to the body organ and a multiplicity of mask images is acquired by X-ray detection at a high image acquisition rate of at least 60 frames per second. Then, contrast medium is injected into vessels of the body organ and subsequently at least one contrast image of the body organ with the contrast medium included in the vessels is acquired by X-ray detection. A matching image from the multiplicity of mask images is determined which has been acquired at substantially the same stage of the movement of the body organ as the contrast image. By calculating the difference between the matching mask image and the at least one contrast image a subtraction image of the body organ can be obtained and displayed. Using different image acquisition rates during mask image acquisition and contrast image acquisition high quality subtraction images can be achieved while at the same time reducing the overall X-ray exposure dose.

### FIELD OF THE INVENTION

The present invention relates to the field of acquiring fusion X-ray images. Particularly, the present invention relates to a method and an apparatus for acquiring fusion X-ray images of a periodically moving body organ. Furthermore, the present invention also relates to a computer program element adapted for controlling such method when executed on a computer and to a computer-readable medium on which such computer program element is stored.

### ART BACKGROUND

The digital fusion of acquired images such as subtraction or overlay of a contrast image and of a mask image is a common technique in angiography used to obtain images of vessels for example in a human body. Therein, an X-ray system with an X-ray source and an X-ray detector can be used to acquire a first X-ray image, herein after usually referred as mask image, and then, e.g. after injecting a contrast medium into the vessels to be observed, to acquire a second X-ray image, herein after usually referred as contrast image. Ideally, the fusion image, i.e. the image which is obtained by fusing images such as by subtracting the mask image from the contrast image, provides exclusive presentation of the contrasted vessels. This procedure is also known as digital subtraction angiography (DSA) and shows good results and is well-established for applications in neurology and imaging of extremities for example of a human body.

Another way of digital fusion of acquired images is so called roadmapping. Therein the ‘mask image’ is recorded after injecting contrast medium into the vessel, while the subsequent ‘contrast images’ only show the advancement of a guide wire or catheter after the contrast medium has been washed out by the blood flow. The fusion of both images shows the position of the guide wire or catheter in the vessel.

In the description below the example of fusion of images as in DSA will be mainly discussed, however without excluding other fusion methods such as in roadmapping.

In applications in which moving body organs are to be observed such as for example in cardiac applications, where the vessels of a beating heart are to be observed, DSA can create artefacts due to the movement of the organ. Especially the fast and complex movements of the heart are responsible for a large amount of subtraction artefacts. Accordingly, current X-ray systems for cardiac diagnostics and interventions do not use the subtraction techniques because too many movement artefacts deteriorate the resulting X-ray images.

There may be a need for an improved method or apparatus for acquiring fusion images which is especially adapted to provide high quality fusion X-ray images of a periodically moving body organ. Such method or apparatus should at least partly overcome for example the above-mentioned deficiencies of prior art methods or apparatus. Particularly, there may be a need for a method or an apparatus for acquiring subtraction X-ray images with reduced blurring and/or with reduced X-ray exposure to a patient.

### SUMMARY OF THE INVENTION

This need may be met by the subject-matter according to the independent claims. Advantageous embodiments of the present invention are described in the dependent claims.

According to a first aspect of the present invention there is provided a method for acquiring fusion images of a periodically moving body organ, the method comprising: irradiating the body organ with X-rays and acquiring a multiplicity of mask images of the body organ by X-ray detection; causing a change in the body organ resulting in a different X-ray absorption at least in parts of the body organ; irradiating the body organ with X-rays and acquiring at least one contrast image of the body organ by X-ray detection; determining at least one matching image out of the multiplicity of mask images such that the matching image and the at least one contrast image are acquired in substantially a same movement stage of the body organ; generating at least one fusion image by fusing the matching image with the at least one contrast image; wherein at least a portion of the multiplicity of mask images of the body organ is acquired with an image acquisition rate of at least 60 frames per second.

This aspect of the invention is based on the idea that a fusion image acquiring method or apparatus can be specifically adapted for imaging moving body organs such as for example a beating heart by implementation of high-speed image acquisition at least for the acquisition of a multiplicity of mask images. Such high-speed image acquisition can be obtained by using specially designed X-ray detectors which are able to acquire X-ray images at a rate higher than the conventional rate. Furthermore, the image acquisition rate can be selected depending on a moving velocity of the corresponding moving body organ.

In the following, further features, advantages and embodiments of the method according to the first aspect will be described in detail.

Preferably, the inventive method shall be performed in the order as outlined above, i.e. the mask images are acquired before causing a change in the body organ resulting in a different X-ray absorption and then the at least one contrast image is acquired. However, it shall be noted that also any other order can be implemented. For example, the multiplicity of mask images can be acquired after causing the change in the body organ resulting in a different X-ray absorption and after acquiring the at least one contrast image.

In the following the preferred order of implementing will be described.

In a first step of the method, the body organ under observation is irradiated with X-rays. These X-rays can be generated by any conventional X-ray source. The X-ray source can be controlled to emit X-rays in a continuous mode or in a pulsed mode. The energy and the intensity of the X-rays can be adjusted to obtain maximum contrast for the resulting X-ray images.

The X-rays transmitted through the body including the body organ to be observed can be detected by an X-ray detector. The X-ray detector can provide a multiplicity of mask images. Herein, a “mask image” may be an X-ray image containing the redundant/background information that needs to be removed. For example, the mask images may be taken of the body organ to be observed before causing a change in the body organ resulting in a different X-ray absorption.

In a second method step, a change in the body organ resulting in a different X-ray absorption at least in parts of the body organ is caused. This change can be caused e.g. by injecting a contrast medium into vessels of the body organ. A contrast medium can be a fluid which heavily absorbs X-rays and which can be introduced into vessels for example by a catheter. Alternatively, an X-ray absorbing tool like a guide wire or a catheter can be moved in the body organ.

In a third step, the body organ is then irradiated with X-rays again. At least one or preferably a plurality of contrast images of the body organ can then be acquired by the X-ray detector. Herein, a “contrast image” may be an X-ray image from which it is desired to remove the background using the “mask image”. For example, the contrast image can be an X-ray image of the body organ which is acquired while at least part of the contrast medium is flowing through vessels of the body organ under observation. As the contrast medium flowing through the vessels heavily absorbs X-rays, the contrast medium filled vessels can be seen as darkened regions in the contrast image(s).

It is to be noted that the above three steps can at least partially overlap in terms of process step duration. That means that e.g. contrast medium can already be introduced while still acquiring some of the mask images. As the contrast medium takes some time to enter into the vessels of the body organ, also in this case mask images of sufficient quality can be obtained. Correspondingly, contrast images can be acquired while introducing further contrast medium into the vessels.

However, in order to reduce the X-ray exposure dose to a patient and in order to reduce the amount of contrast medium to be introduced into the patient, it can be advantageous to separate the above-mentioned three processes.

Furthermore, it can be advantageous that the above three method steps are performed in a direct sequence that means without substantial time gaps between the respective steps. For example a time interval between the respective steps should be less than 5 s, preferably less than 1 s. This might have the advantage of a short overall time interval for the entire acquisition of mask images and contrast images. During such short acquisition time interval e.g. the pulse of an observed heart may not vary substantially which will lead to advantages for subsequent process steps as will become apparent from the following description.

As a next step it is determined, which of the previously acquired mask images has been acquired in substantially the same movement stage of the body organ as the at least one contrast image. This mask image is referred as the “matching image”. In other words, a mask image out of the multiplicity of mask images is determined which has been acquired in substantially the same phase of the periodical movement of the body organ as the at least one contrast image.

In the following this will be explained with respect to an example of a beating heart as the periodically moving body organ. The heart beats at a certain pulse which is not necessarily constant. Although the period of a pulse may vary, the heart repeatedly goes through a predetermined sequence of movement stages. After being fully filled the heart pumps the blood by contraction and is then refilled by expansion. In each stage of the movement the heart has a different volume and therefore the vessels of the heart have a different position. Accordingly, when a contrast image is acquired at a certain movement stage a mask image which has been acquired at a corresponding movement stage in an earlier pulse is searched in the step of determining and is referred as the matching image.

In a next step a fusion image is generated by fusing the contrast image with the matching image. Fusing of images may be implemented by merging the images in various ways. For example, the corresponding pixels of the images can be merged according the a specific mathematic function using e.g. subtraction, division, etc. As both images have been acquired at corresponding movement stages of the body organ, the position and size of the body organ and of the included vessels are essentially the same in both images.

In the following, generating subtraction images will be explained as one preferred example of generating fusion images. By subtracting the detected X-ray values of the two images for each pixel of the images a subtraction image can be obtained in which all regions apart of the vessels have a value of essentially zero which in the subtraction image can be represented as white regions. Only the regions of the vessels, as a result of different absorption values during mask image acquisition and contrast image acquisition, show non-zero values which may be represented in the subtraction image as dark regions.

An important characteristics of the method according to the invention is that at least a portion of the multiplicity of mask images of the body organ is acquired with an image acquisition rate higher than conventional acquisition rates, e.g. with an acquisition rates of at least 40 or preferably at least 60 frames per second. A higher image acquisition rate of for example at least 100 frames per second, preferably at least 150 frames per second and more preferred at least 300 frames per second can be advantageous. Furthermore, it may be preferred to acquire all of the multiplicity of mask images with the above-mentioned high image acquisition rate.

Alternatively the mask images may be acquired with a lower frame rate (e.g. 30 fps) during more than one period of the periodically moving body organ. Based on image analysis or analysis of a simultaneously recorded physiologic signal (e.g. the electrocardiogram or blood pressure) the images from these periods may be interlaced into a single period with an equivalent minimum frame speed of approximately 60 fps.

Although the implementation of such high image acquisition rate may require the use of a specifically designed fast X-ray detector with a short integration time or the interlacing of slowly acquired mask images it may result in a number of advantages. For example, each of the acquired mask images may show less blur caused by the movement of the body organ as the integration time for acquiring a single image or frame is relatively short, e.g. shorter than 25 ms, preferably shorter than 10 ms and more preferred shorter than 4 ms. Furthermore, as a large number of mask images can be obtained for a single period of the movement of the moving body organ there will be a large variety of mask images for different movement stages of the body organ such that a better matching between the at least one contrast image and the matching image of the multiplicity of mask images can be achieved. Accordingly, due to the high image acquisition rate during mask image acquisition the subtraction image can be generated with reduced blur and increased contrast.

According to an embodiment of the invention not only one contrast image but a multiplicity of contrast images of the body organ is acquired and the multiplicity of mask images is acquired with a higher image acquisition rate than the multiplicity of contrast images. In other words, during performing the method according to the invention different image acquisition rates are used for acquiring the mask images and the contrast images. While it may be advantageous to acquire as many mask images as possible for different movement stages within one period of the periodical movement of the body organ in order to find a best match between an acquired contrast image and one of the mask images, it may be sufficient to acquire the contrast images with an acquisition rate of less than the acquisition rate of the mask image acquisition, e.g. less than 30 frames per second, preferably less than 10 frames per second and possibly less than 1 frame per second. This may reduce both the X-ray exposure dose to a patient as well as the necessary computing capacity for determining matching images and generating the subtraction images.

According to another embodiment of the present invention the body organ is irradiated continuously with X-rays during acquiring the multiplicity of mask images. As it may be preferable to acquire as many mask images as possible during one single period of the movement of the body organ, it may be advantageous to irradiate the body organ continuously without intermittently switching off the X-ray source. Mask images can then be acquired without time gaps between successive images.

According to another embodiment of the present invention the body organ is irradiated with X-rays in a pulsed mode during acquiring of the multiplicity of contrast images. As the contrast images may be acquired with a lower acquisition rate there may be time gaps between the acquisition of successive contrast images. By operating an X-ray source in a pulsed mode wherein X-rays are only emitted when an X-ray detector is operated to acquire an X-ray image, the overall X-ray dose irradiated to a patient can be reduced.

According to a further embodiment of the present invention the step of determining of the at least one matching image is performed by comparison of characteristics of images out of the multiplicity of mask images and of the at least one contrast image. For example, a characteristic structure of the body organ or a feature associated to the body organ can be determined for each of the mask images and contrast images and by comparison of the position of the structure or the feature the matching image can be determined.

For example, when observing a beating heart during a surgical operation a catheter is usually introduced into one of the vessels of the heart. This catheter and its position can be observed on each of the X-ray images. The catheter moves together with the movement of the heart. In the matching mask image the catheter should have substantially the same position as in the respective contrast image.

A general image comparison process may use a similarity measure S, which has as input a (mask) image M, and a (contrast) image C and determines the similarity between the images. Letting Cⱼ be a series of contrast images and Mᵢ a series of mask images then the best match of a contrast image Cₖ is determined by finding the (local) maximum of the similarity over all mask images Mᵢ

At this point, it should be noted that the method according to the invention may be applied for acquiring subtraction images of various types of periodically moving body organs. One especially preferred application is cardiac diagnostics and interventions. The heart is a rapidly moving body organ and the period of its movement is usually about one second. However, there are various other organs which perform more or less extended periodical movements and the inventive method can also be used for acquiring subtraction images of high quality of such organs. This is especially true for the case that a multiplicity of contrast images is acquired during one pulse such that the blood flow through the vessels can be visualized by sequentially presenting the generated subtraction images as in a movie (as will be explained later herein).

According to another embodiment, the inventive method is especially adapted for acquiring fusion images such as subtraction images of a periodically moving heart. In such embodiment, the method further comprises acquiring physiologic data of the heart and vessels such as ECG (electrocardiogram) data or blood pressure data. These data can be used for example for triggering specific method steps.

According to an embodiment of the present invention, the starting point of time for acquiring the multiplicity of mask images is determined based on the ECG data. In other words, the ECG data are used for triggering the acquisition of the mask images. For example, the acquisition can be triggered based on the ECG data such that the mask image acquisition is started during a rapid movement of the heart, for example in the systolic phase of the heart, or during a slow movement of the heart, for example during the diastolic phase.

According to another embodiment the starting point of time for introducing the contrast medium into vessels of the body organ is determined based on the physiological data such as e.g. the ECG data. It may be particularly advantageous to trigger both the mask image acquisition and the contrast medium injection based on the physiological data. For example, the mask image acquisition can be started during a rapid movement phase of the heart directly after the R-peak of the ECG data and the contrast medium injection can be started within the same pulse period but in the following slow movement phase.

According to another embodiment the starting point of time for acquiring the at least one contrast image is determined based on the physiological data such as e.g. the ECG data. It can be particularly advantageous to trigger both the mask image acquisition and the contrast image acquisition based on the ECG data. For example, the mask image acquisition can be performed during a short fraction of the pulse period after a specific signal of the ECG, as for example the R-peak, and then, time shifted by at least one heart pulse period, the contrast image acquisition is started within the same time fraction of the pulse period. Such ECG data based coupling of mask image acquisition and contrast image acquisition can contribute to reducing the necessary overall X-ray exposure dose.

According to another embodiment, the starting point of at least one of the above-mentioned method steps, i.e. the mask image acquisition, the contrast medium introduction or the contrast image acquisition, is determined by use of phase-locked loop (PLL) triggering. With PLL the acquisition frequency can be made a multiple of the physiological data such as e.g. the ECG frequency. In this way it is not necessary to acquire mask images continuously during a whole heart cycle, but only in bursts around specified phases during the cycle at which phases also the contrast images will be or have been acquired. This will reduce the required X-ray exposure.

In another aspect of the present invention an apparatus for X-ray fusion image acquisition is provided which is adapted to perform the above-described inventive method. Such apparatus can include an X-ray source for emitting X-rays; an X-ray detector for acquiring X-ray images of an X-ray body organ; a contrast medium injector for introducing a contrast medium into vessels of a patient; a control unit for controlling at least one of the X-ray source, the X-ray detector and the contrast medium injector; a computing unit for computing a subtraction image based on two X-ray images provided by the X-ray detector.

Therein, the apparatus can be specifically adapted for acquiring X-ray images at different image acquisition rates. For example, the X-ray source can be operated in a pulsed mode wherein the pulse duration and pulse rate can be controlled by the control unit. Alternatively, the X-ray detector can be controlled to operate at different integration times and at different image detection rates. It can be preferred to use an X-ray detector which can be operated with a high-speed acquisition rate higher than conventional X-ray acquisition frame rates and e.g. more than 60 frames per second, preferably more than 100 frames per second, and more preferred more than 300 frames per second in a first mode and which can be operated in a second mode with either a high-speed acquisition rate or acquisition rates comparable to conventional acquisition rates such as e.g. of less than 30 frames per second, preferably less than 10 frames per second.

Another aspect of the present invention is directed to a computer program element which is adapted to perform the method for acquiring subtraction images as outlined above when executed on a computer.

Another aspect of the invention is directed to a computer-readable medium with such computer program element.

It has to be noted that embodiments of the invention are described with reference to different subject-matters. In particular, some embodiments are described with reference to method type claims whereas other embodiments are described with reference to apparatus type claims. However, a person skilled in the art will gather from the above and the following description that, unless other notified, in addition to any combination of features belonging to one type of subject-matter also any combination between features relating to the different subject-matters, in particular between features of the apparatus type claims and features of the method type claims, is considered to be disclosed with this application.

The aspects defined above and further aspects, features and advantages of the present invention can be derived from the examples of embodiments described hereinafter.

The invention will be described in more detail hereinafter with reference to examples of embodiments but to which the invention is not limited.

### BRIEF DESCRIPTION OF THE DRAWINGS

FIGS. 1 to 4 schematically show time diagrams from which time dependencies between process steps of methods according to different embodiments of the present invention can be derived;

FIG. 5 shows a subtraction X-ray image acquired with a method according to the present invention at the time of arterial inflow of contrast medium into the heart;

FIG. 6 shows a subtraction X-ray image corresponding to the one of FIG. 5 at a later stage of contrast medium inflow;

FIG. 7 schematically shows an apparatus for X-ray subtraction image acquisition according to an embodiment of the present invention.

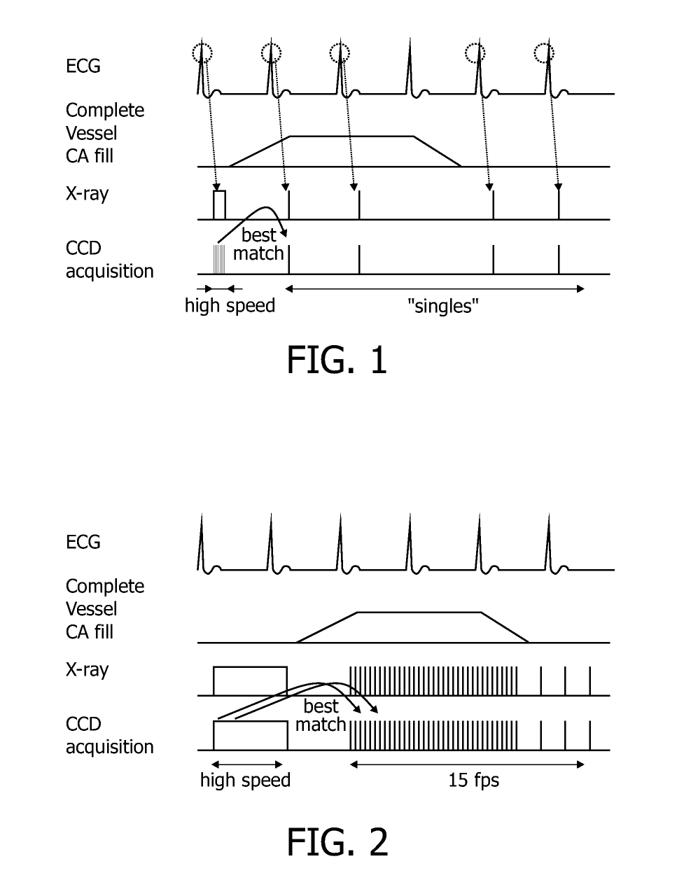

In FIGS. 1 to 4, time dependencies between the various process steps of embodiments of the inventive image acquisition method are represented. In the first row an ECG (electrocardiogram) signal is shown. The second row shows the filling status of a contrast agent (CA) in vessels of a body organ to be observed. The third row shows the X-ray intensity irradiated onto the body organ. The fourth row represents the image acquisition by a high speed X-ray detector.

FIG. 1 refers to a first embodiment of the image acquisition method according to the invention. Starting at a specific point of time which can be determined based on the ECG signal X-rays are irradiated onto a patient in a region of a body organ to be observed, in this case the heart. The X-rays are continuously irradiated during a time interval which is significantly shorter than the period of the pulse indicated by the ECG signal. During this continuous X-ray irradiation X-ray images are acquired by a high speed detector at a high image acquisition rate of for example 300 frames per second. Due to the high image acquisition rate some fifty or more mask images can be acquired during the short X-ray irradiation time interval. Briefly after stopping the acquisition of mask images and preferably during the same pulse period contrast medium is introduced into the vessels of the body organ.

In the following pulse periods single contrast images are acquired by the high speed detector. The timing for such contrast image acquisition can be based on the ECG signal. The contrast image acquisition should be performed within a time interval which corresponds to the same phase of the movement of the heart as the time interval used for mask image acquisition. For example, the contrast images can be acquired approximately at a phase of the heart cycle which corresponds to the middle of the time interval for mask image acquisition.

It is to be noted that contrast images are not only acquired during complete fill of the vessels of the heart with contrast medium, wherein this time interval is usually referred as the “arterial phase”, but also in later time intervals when the contrast medium begins to spread throughout the heart and travels to the myocard, wherein this time interval is usually referred as the “perfusion phase”.

After acquiring the multiplicity of mask images and the contrast images the mask image which corresponds best to a respective contrast image is determined by comparison of characteristics of both images. Then, an image subtraction of the best matching mask image and the respective contrast image is performed. The resulting subtraction X-ray image can be displayed on a screen for example.

By acquiring a large multiplicity of mask images with a high acquisition rate during a relatively short time interval and then acquiring single contrast images during subsequent pulses within a corresponding phase of the heart movement, high quality subtraction images can be obtained and at the same time the X-ray exposure dose can be minimized.

In FIG. 2, time dependencies for a second embodiment of the method of the present invention are shown. Therein a multiplicity of mask images is acquired at a fast acquisition rate of 300 frames per second. The acquisition is triggered by the ECG signal. The mask image acquisition is performed during a time interval which is equal to or longer than one pulse period indicated by the ECG signal. After the injection of a contrast medium, wherein the injection is also triggered by the ECG signal, a plurality of contrast images is acquired during the arterial phase.

While X-rays are irradiated continuously during the mask image acquisition time interval, X-rays are irradiated in a pulsed mode during contrast image acquisition. That means, that X-ray emission by an X-ray tube and X-ray image detection by a high speed X-ray detector are synchronized. X-rays are emitted for a short time interval of for example 10 ms and at the same time the high speed detector integrates the detected X-ray intensity. Before acquiring the next contrast image, for example 100 ms later, both the X-ray source and the X-ray detector are inactive. Using such pulsed X-ray emission mode the X-ray dose to a patient can be reduced.

By acquiring a multiplicity of contrast images within one pulse period, determining the corresponding matching mask images out of the multiplicity of previously acquired mask images for each contrast image and then generating a subtraction image for each pair of contrast and mask image, a sequence of subtraction images of different moving stages of the observed heart can be obtained which can be displayed as a movie of the moving organ.

In FIG. 2, it can be seen that three different modes of X-ray acquisition are used. During mask image acquisition a high-speed acquisition rate of 300 frames per second is used. For contrast image acquisition in the arterial phase a reduced image acquisition rate of about 15 frames per second is used. Finally, for observing processes in the vessels of the heart during the perfusion phase, a further reduced acquisition rate of less than about 5 frames per second is used.

FIG. 3 shows another embodiment in which for both the mask image acquisition and the contrast image acquisition high acquisition rates are used. Using such high acquisition rates also for the contrast image acquisition, a sequence of subtraction X-ray images can be obtained with high temporal resolution which might help in the analysis of fast processes within the vessels of the heart.

FIG. 4 shows the time dependencies for another embodiment wherein the mask images are acquired in a plurality of short time intervals having pause intervals in between. If the time interval between each successive pair of masks is for example 100 ms then the time interval between successive pairs of contrast images should be the same and the images should be acquired in the same cardiac phase. During each mask image acquisition interval X-rays are irradiated continuously and a multiplicity of mask images is acquired with a high acquisition rate.

During the arterial phase and the perfusion phase, contrast images are acquired within phases of the heart cycle which correspond to the phases in which the mask images have been acquired.

By synchronizing the acquisition of mask images in short time intervals and the acquisition of contrast images and by switching off the X-ray source during time intervals in between such mask image acquisition intervals, the overall X-ray dose can be reduced.

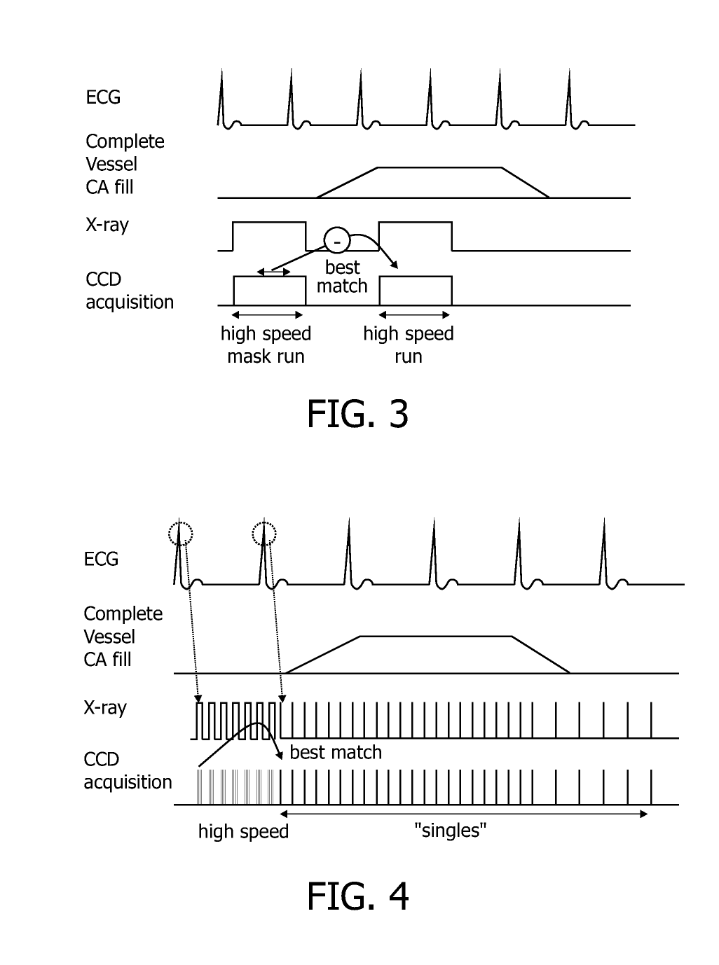

FIG. 5 shows an X-ray image acquired in accordance with the method of the present invention. The image has been generated by subtraction of the matching one of a plurality of mask images and a contrast image acquired during the arterial phase.

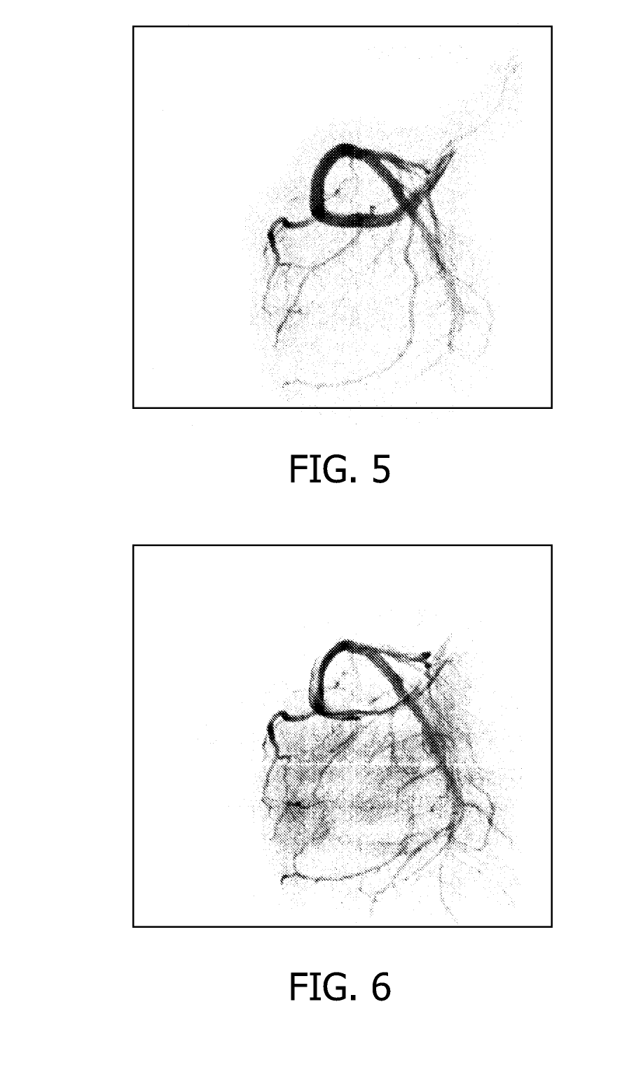

FIG. 6 shows a corresponding subtraction image which was generated using a contrast image acquired during the perfusion phase. As in the perfusion phase the contrast medium has already spreads throughout the myocard lots of fine vessels of the heart can be observed. Especially for the observation of such fine vessel structures the increased image quality and the reduced blur which can be obtained with the method according to the invention can be a substantial advantage.

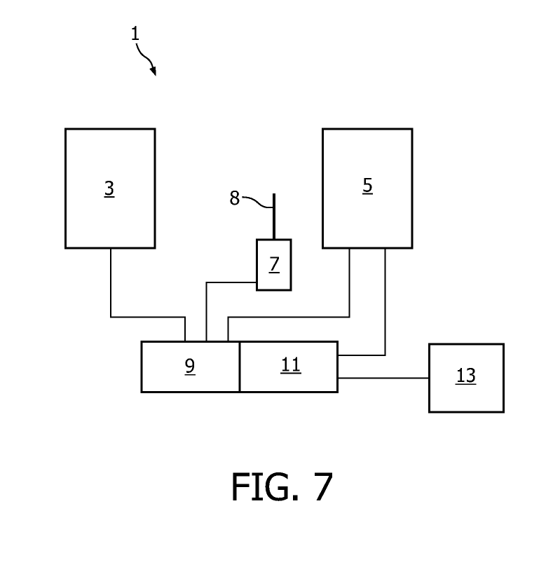

FIG. 7 very schematically shows an embodiment of an apparatus for X-ray subtraction image acquisition which is adapted to perform the above-described method according to the invention.

The apparatus 1 comprises an X-ray source 3 for emitting X-rays, an X-ray detector 5 for acquiring X-ray images, a contrast medium injector 7 having an injector needle 8 for introducing a contrast medium into vessels of a patient, a control unit 9 controlling at least one of the X-ray source 3, the X-ray detector 5 or the contrast medium injector 7, and a computing unit 11 for computing a subtraction image based on two X-ray images provided by the X-ray detector. The computing unit 11 can output the computed subtraction images to a display 13.

The apparatus 1 is adapted for acquiring X-ray images at different image acquisition rates. For this purpose it can use an X-ray detector which is able and can be controlled to acquire X-ray images both at a high image acquisition rate of more than 60 frames per second and at a low image acquisition rate of less than 30 frames per second.

In order to recapitulate the above-described embodiments and aspects of the present invention it can be summarized: A method for acquiring subtraction images of a periodically moving body organ and an apparatus adapted to implement such method is described. In the method, X-rays are irradiated to the body organ and a multiplicity of mask images is acquired by X-ray detection at a high image acquisition rate of at least 40 frames per second. Then, contrast medium is injected into vessels of the body organ and subsequently at least one contrast image of the body organ with the contrast medium included in the vessels is acquired by X-ray detection. A matching image from the multiplicity of mask images is determined which has been acquired at substantially the same stage of the movement of the body organ as the contrast image. By calculating the difference between the matching mask image and the at least one contrast image a subtraction image of the body organ can be obtained and displayed. Using different image acquisition rates during mask image acquisition and contrast image acquisition high quality subtraction images can be achieved while at the same time reducing the overall X-ray exposure dose.

Embodiments of the present invention may offer the following advantages:

A maximum of information can be obtained using a minimal X-ray dose by using variable acquisition speeds. Furthermore, a maximum of qualitative information using a minimum of contrast medium can be obtained by using cardio subtraction which enhances the contrast medium visibility compared with non-subtracted runs, pleading for a reduction of contrast medium usage.

Concerning an apparatus for implementing the method, an extra computation unit may be added to obtain quantitative information for example on flow and perfusion in a moving body organ as a heart.

It shall be noted that the application of fast imaging and subtraction is not restricted to cardio applications but is also applicable to other vessels for studying flow and perfusion.

Furthermore, it shall be noted that coronary road-mapping could be provided with image overlays of the results of a coronary digital subtraction image acquisition as described in this application, optionally combined with known methods for cardiac and respiration motion compensation. For example, when a fusion image such as a DSA image is acquired, it can be fused with conventionally acquired images as used e.g. in coronary road mapping.

It should be noted that the terms “comprising”, “including” etc. do not exclude other elements or steps and the “a” or “an” does not exclude a plurality. Also elements described in association with different embodiments may be combined. It should also be noted that reference signs in the claims should not be construed as limiting the scope of the claims.

1. A method for acquiring fusion images of a periodically moving body organ, the method comprising:
irradiating the body organ with X-rays and acquiring a multiplicity of mask images of the body organ by X-ray detection;
causing a change in the body organ resulting in a different X-ray absorption at least in parts of the body organ
irradiating the body organ with X-rays and acquiring at least one contrast image of the body organ by X-ray detection;
determining at least one matching image out of the multiplicity of mask images such that the matching image and the at least one contrast image have been acquired in substantially a same movement stage of the body organ;
generating at least one fusion image by fusing the matching image with the at least one contrast image;
wherein at least a portion of the multiplicity of mask images of the body organ is generated with an minimum rate of at least 60 frames per second.

2. The method according to claim 1, wherein the image acquisition rate is selected depending on a moving velocity of the corresponding moving body organ.

3. The method according to claim 1, wherein
generating the at least one fusion image comprises subtracting the matching image from the at least one contrast image in order to obtain a subtraction image.

4. The method according to claim 1, wherein
a multiplicity of contrast images of the body organ is acquired and
wherein the multiplicity of mask images is acquired with a higher image acquisition rate than the multiplicity of contrast images.

5. The method according to claim 4, wherein
the multiplicity of contrast images is acquired with an image acquisition rate of less than 30 frames per second.

6. The method according to claim 1, wherein
the body organ is irradiated continuously with X-rays during acquiring the multiplicity of mask images.

7. The method according to claim 4, wherein
the body organ is irradiated with X-rays in a pulsed mode during acquiring the multiplicity of contrast images.

8. The method according to claim 1, wherein
the determining of the at least one matching image is performed by comparison of characteristics of images out of the multiplicity of mask images and of the at least one contrast image.

9. The method according to claim 1, wherein
the method is adapted for acquiring subtraction images of a periodically moving heart,
the method further comprising acquiring physiologic data of the heart cycle.

10. The method according to claim 9, wherein
the starting point of time for acquiring the multiplicity of mask images is determined based on the physiologic data.

11. The method according to claim 9, wherein
the starting point of time for introducing the contrast medium into vessels of the body organ is determined based on the physiologic data.

12. The method according to claim 9, wherein
the starting point of time for acquiring the at least one contrast image is determined based on the physiologic data.

13. The method according to claim 10, wherein
the starting point of time is determined using phase locked loop triggering.

14. Apparatus for X-ray subtraction image acquisition adapted to perform the method according to claim 1.

15. Apparatus according to claim 14, including
an X-ray (3) source for emitting X-rays;
an X-ray detector (5) for acquiring X-ray images of an x-rayed body organ;
a contrast medium injector (7) for introducing a contrast medium into vessels of a patient;
a control unit (9) for controlling at least one of the X-ray source (3), the X-ray detector (5) and the contrast medium injector (7);
a computing unit (11) for computing a fusion image based on two X-ray images provided by the X-ray detector (5);
wherein the apparatus is adapted for acquiring X-ray images at different image acquisition rates.

16. Computer program element adapted to perform the method according to claim 1 when executed on a computer.

17. Computer readable medium with a computer program element according to claim 16.
